(19) United States
(12) Patent Application Publication
(10) Pub. No.: US 2013/0233182 A1
(43) Pub. Date: Sep. 12, 2013

(54) ROTISSERIE OVEN

(71) Applicants: Ronald Eugene Hunt, Georgetown, TX (US); Donnie Lee Miller, Austin, TX (US); Verlon Eugene Whitehead, Austin, TX (US)

(72) Inventors: Ronald Eugene Hunt, Georgetown, TX (US); Donnie Lee Miller, Austin, TX (US); Verlon Eugene Whitehead, Austin, TX (US)

(73) Assignee: CD3 HOLDINGS, INC., Austin, TX (US)

(21) Appl. No.: 13/417,018

(22) Filed: Mar. 9, 2012

(51) Int. Cl. A47J 37/04; B23P 11/00

(52) U.S. Cl. 99/341; 99/421 R; 29/428

(57) ABSTRACT

Rotisserie ovens comprise upper and lower enclosure members forming a cooking chamber therebetween and having a heating assembly therein. The upper member is movable and removably attached to the lower member. The cooking chamber is configured to accommodate a spit assembly that is rotated by an electric motor in the lower member. The lower member includes one or more support members operable to orient the oven in a cooking or a storage position, wherein the height profile of the oven in the storage position is about 50 percent or less then in a cooking position. The upper member is configured for storage placement within the lower member cooking chamber when removed therefrom and inverted, and the spit assembly when disassembled resides within a space between the inverted upper member and lower member to provide a compact low-profile self-contained package for placement and storage within a kitchen drawer or the like.

### FIELD OF THE INVENTION

The invention relates to a cooking appliance and, more specifically, to a counter-top rotisserie oven that is specially engineered having space saving and other storage and operating features that provide desired improvements over conventional rotisserie ovens.

### BACKGROUND

Indoor cooking appliances are known in the art and include stoves, toasters, broilers, and countertop-ovens such as rotisserie ovens. Rotisserie ovens known in the art are typically configured having a fixed-size outer housing that defines a cooking chamber within, wherein the cooking chamber includes one or more heating elements for cooking the desired food article. Such rotisserie ovens conventionally have an elongated cooking chamber that is configured to accommodate a chicken or other food article within.

Additionally, such rotisserie ovens are configured to accommodate the food article within the cooking chamber on a spit of the like that enables the food article to be rotated within the cooking chamber to provide a uniformly cooked result. Such rotisserie ovens may also include temperature controls or timers or the like, that control or actuate the heating elements and/or spit to facilitate cooking the food article without constant supervision.

While such rotisserie ovens are known in the art, they are made having a fixed-outer housing shape or size, that presents a somewhat bulky spatial package that is either left on the kitchen counter when it is not being used, which occupies sometimes precious counter space, or that is difficult to store if removed from the kitchen counter, sometimes requiring storage in a closet, pantry or even a garage.

It is, therefore, desirable that a counter-top rotisserie oven be configured in a manner that is capable of operating in a manner that is the same or improved when compared to conventional rotisserie ovens. Additionally, it is desired that such a counter-top rotisserie oven be configured in a manner that enables it to be easily stored when not being used, for example within a kitchen drawer or the like, to thereby avoid the need to consume precious kitchen counter space for storage.

### SUMMARY OF THE INVENTION

Countertop cooking devices such as ovens and rotisserie ovens as disclosed herein generally comprise a two-piece enclosure or housing formed from a lower member and an upper member. In an example embodiment, the upper member is removably connected to the lower member to form a cooking chamber therebetween, and is movable relative to the lower member, e.g., can be tilted upwardly, to permit access to the cooking chamber. The enclosure includes a heating assembly, e.g., comprising one or more heating elements, disposed therein and positioned to facilitate the cooking of a food article within the cooking chamber when activated. The enclosure can include switches and controls to adjust/set the time and/or temperature of the cooking operation.

In an example embodiment, the cooking chamber is configured to accommodate a spit assembly disposed therein for rotatable movement during a cooking operation. The spit assembly comprises a pair of opposed plates with two or more spit rods extending therebetween. In an example embodiment, the spit assembly is disassembled by removing the rods from the plates to facilitate storing the disassembled spit assembly parts within the cooking chamber. The enclosure includes a motorized mechanism to facilitate rotating the spit assembly therein through the use of geared engagement.

The enclosure includes one or more support members connected thereto for selectively moving the enclosure between a first storage position (when not in use) and a second operating or cooking position (when used to cook a food article). When in the storage position, the cooking enclosure lower member is oriented having a reduced height profile relative to a horizontal support surface as compared to when the enclosure lower member is in the operating or cooking position. In an example embodiment, the support members are positioned along a rearward bottom surface of the enclosure lower member, and positioned to extend therefrom to place the enclosure in a forward-oriented position.

The enclosure lower member includes a front edge and a rear edge. When the enclosure lower member is positioned in the storage position, the height of the front and rear edges are substantially the same as measured from a horizontal support surface. When the enclosure lower member is positioned in the cooking position, the rear edge is oriented substantially higher than the front edge. In an example embodiment, the height of the rotisserie oven in the stored position is less than about 75 percent of the height of the rotisserie oven in the cooking position, is less than about 65 percent of the height, and in a preferred embodiment is about 50 percent or less of the height of the rotisserie oven in the cooking position to facilitate easy and convenient storage.

The enclosure upper member is configured so that it can be inverted and fitted within the enclosure lower member cooking chamber. In an example embodiment, at least 75 percent of the upper member fits within the lower member. In an example embodiment, the lower member has a semi-cylindrical configuration, and the upper member has a semi-cylindrical configuration sized to fit concentrically within the lower member when detached from the lower member and inverted. When in a stored configuration, with the upper member inverted and disposed within the lower member, a sufficiently sized space exists between the upper and lower members to accommodate storage of the disassembled spit rod plates and rods therein.

Thus, rotisserie ovens as disclosed herein are configured to provide a space-saving low-height profile for storage purposes to thereby enable the oven and its contents, e.g., the spit assembly, to be easily stored in a kitchen drawer or the like, avoiding the need to needlessly occupy valuable kitchen counter space and/or to be stored inconveniently outside of the kitchen, allowing it to always be close by and readily available for repeated use.

### BRIEF DESCRIPTION OF THE DRAWINGS

These and other features and advantages of the present invention will be appreciated as the same becomes better understood by reference to the following detailed description when considered in connection with the accompanying drawings wherein:

FIG. 1 is a perspective view of an example embodiment rotisserie oven as described herein with top cover in a closed position;

FIG. 2 is a perspective view of the an example embodiment rotisserie oven as described herein with the top cover in an open position and including a spit assembly disposed within a cooking chamber;

FIG. 3 is a front view of the example embodiment rotisserie oven shown in FIG. 1;

FIG. 4 is a top view of the example embodiment rotisserie oven shown in FIG. 1;

FIG. 5 is a side view of the example embodiment rotisserie oven shown in FIG. 1;

FIG. 6 is a side cross-sectional view of the example embodiment rotisserie oven shown in FIG. 1 now illustrated in a storage condition with the top cover removed and a spit assembly disassembled and stored within the cooking chamber;

FIG. 7 is a side cross-sectional view of the example embodiment rotisserie oven shown in FIG. 6 now illustrated in a storage condition the top cover invertedly disposed within the cooking chamber; and

FIGS. 8A and 8B illustrated rear perspective views of an example embodiment rotisserie oven as described herein showing the placement of rear support members.

### DETAILED DESCRIPTION

Rotisserie ovens as disclosed herein are specifically designed to permit easy, space-saving storage to thereby maximize kitchen counter surface area when not in use. Such Rotisserie ovens generally comprise a lower enclosure or housing member that includes a cooking chamber therein and that includes a motor for rotating a spit assembly, on which a food article is disposed during a cooking operation, within the cooking chamber. An upper enclosure or housing member is removably disposed over the lower member to define and enclose the cooking chamber. The rotisserie oven is configured to facilitate cooking a food article when positioned in a cooking orientation or position, and to facilitate self-contained storage by providing a reduced height profile when placed in a storage orientation or position, wherein “self-contained” refers to the fact that the spit assembly is contained within the rotisserie oven when placed in the storage position.

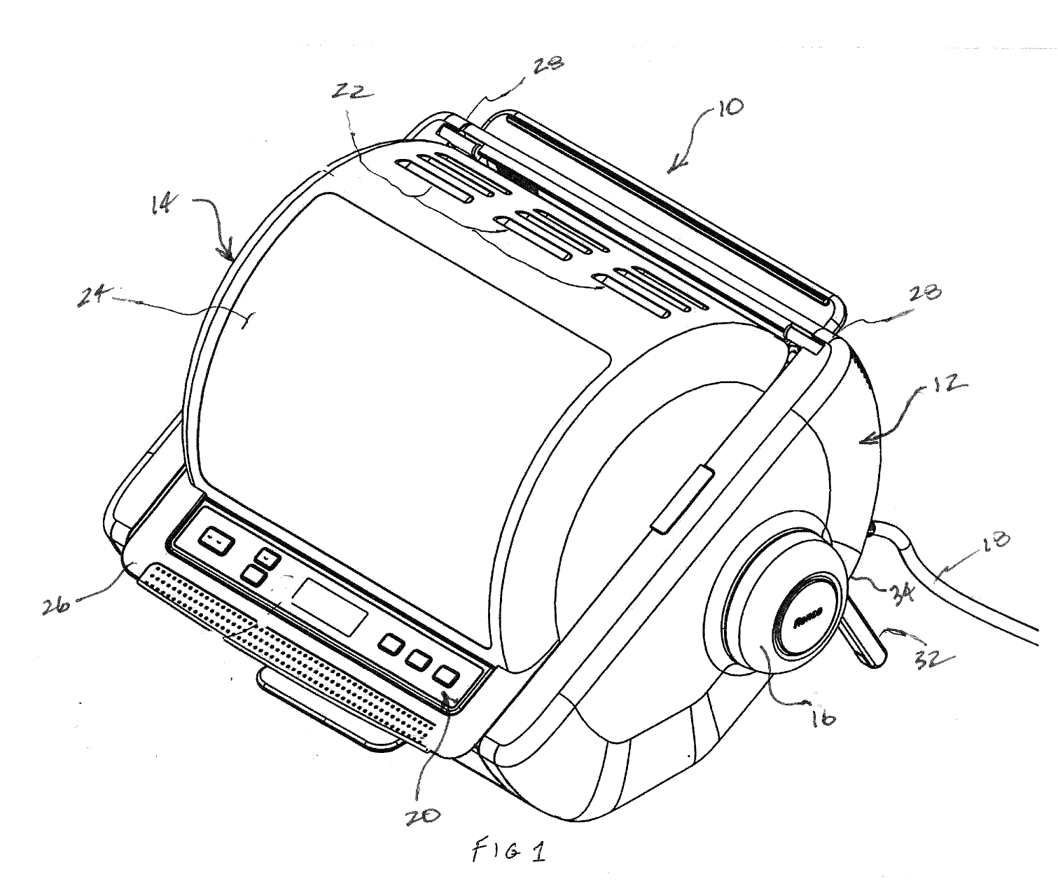

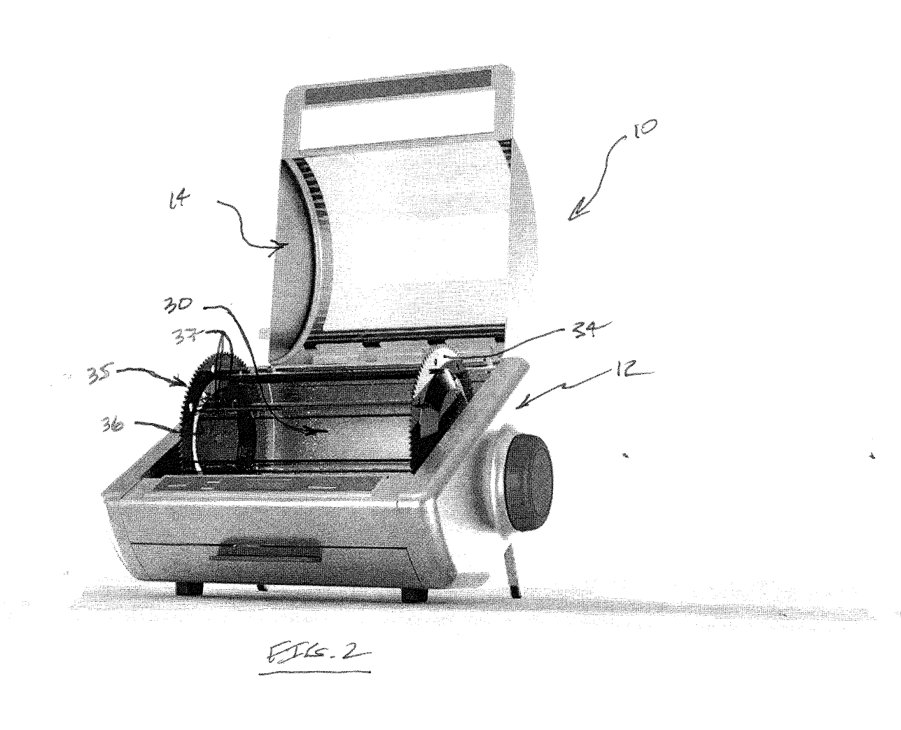

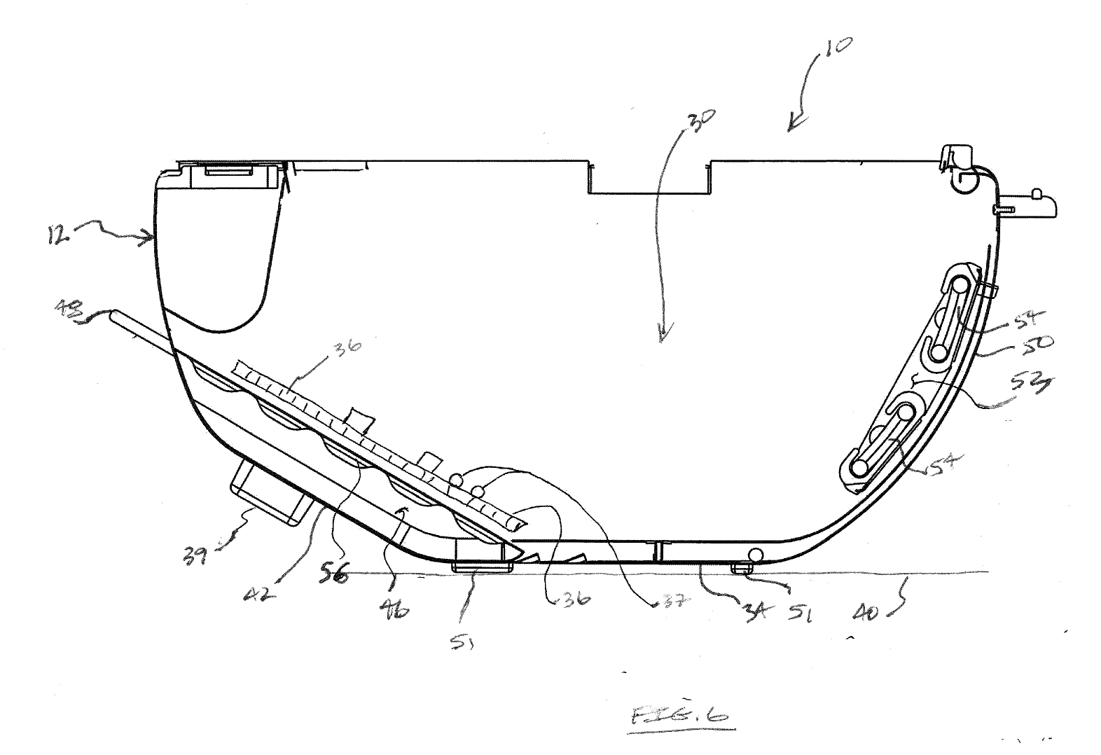

FIG. 1 illustrates a perspective view of an example embodiment rotisserie oven 10 as disclosed herein having an outer enclosure or housing comprising a lower enclosure or housing member 12, and an upper enclosure or housing member 14 disposed over the lower member. In an example embodiment, the lower member is made from a metallic material and is configured to provide a cooking chamber of desired size and configuration therein (as shown in FIGS. 2 and 6). In an example embodiment, the lower member is configured having a generally cylindrical shape, and is adapted for setting on a horizontal support surface.

In an example embodiment, the lower member 12 includes a motorized mechanism 16 disposed therein or attached thereto that is configured to engage and actuate rotation of a spit assembly or the like that is disposed within the cooking chamber. In an example embodiment, the motorized mechanism is provided in the form of an electric motor, and the electricity for the electric motor is provide by an electrical cord 18 extending from the lower member. The lower member can include one or more control features, such as on/off switches and/or timers for the motorized mechanism and/or for a heating assembly disposed within the oven, as well as an indicator of the cooking temperature and/or cooking time. Such control features can be positioned along a panel 20 positioned along a front edge of the lower member 12.

The upper member 14 is positioned over the lower member and in an example embodiment is configured having a generally cylindrical shape that complements that of the lower member. The upper member can also be formed from a metallic material. In an example embodiment, the upper member includes a number of vents or openings 22 extending through a wall surface to optimize cooking In an example embodiment, the upper member includes a plurality of vents that are located toward a rear portion of the upper member. Additionally, the upper member can be configured having a transparent window 24, e.g., a domed window, positioned towards a front portion of the upper member, to facilitate viewing the food article being cooked from a position outside of the oven.

In an example embodiment, the upper member 14 is configured so that it can be tilted upwards away from a front portion of the lower member by pivoting action of the upper member along a rear portion of the lower member. In an example embodiment, the upper member comprises engagement members or features 28 positioned along a rearward portion that are configured to cooperate with respective engagement members or features in the lower member. In an example embodiment, the upper member engagement members are provided in the form of a tongue that engages a respective groove position at a rearward position of the lower member. This arrangement of cooperative engagement members enable the upper member to be tilted upwardly through the use of an upper member handle 26 positioned at the front of the upper member 14.

As best shown in FIG. 2, the arrangement of cooperating engagement members or features enable the upper member 14 to be tilted upwardly away from the lower member 12 to fully expose a cooking chamber 30 for the purpose of placing a food article therein and removing a food article therefrom. A further feature of such cooperating engagement members or features is that they permit the upper member to be easily removed from the lower member for cleaning and/or storage. While a particular type of engagement mechanism between the upper and lower members has been disclosed, many other types of engagement mechanisms capable of providing similar or comparable movement and removal of the upper member are understood to be interchangeably used within the scope of this disclosure.

The lower member 12 includes one of more rear support elements 32 that are positioned along a lower member bottom surface, specifically a rearward surface 34. In an example embodiment, the rear support elements 32 are configured to place and maintain the lower member 12 in a forward-oriented cooking position when the rotisserie oven is in cooking operation, as will be described in greater detail below. In such an example embodiment, the support elements are configured to be movable between a cooking position where they extend outwardly away from the bottom rearward surface 34, and a storage position where they removed, retracted or otherwise are moved to be adjacent to the bottom rearward surface to thereby enable the lower member to be moved to a rearward-oriented storage position, reducing the lower members height profile.

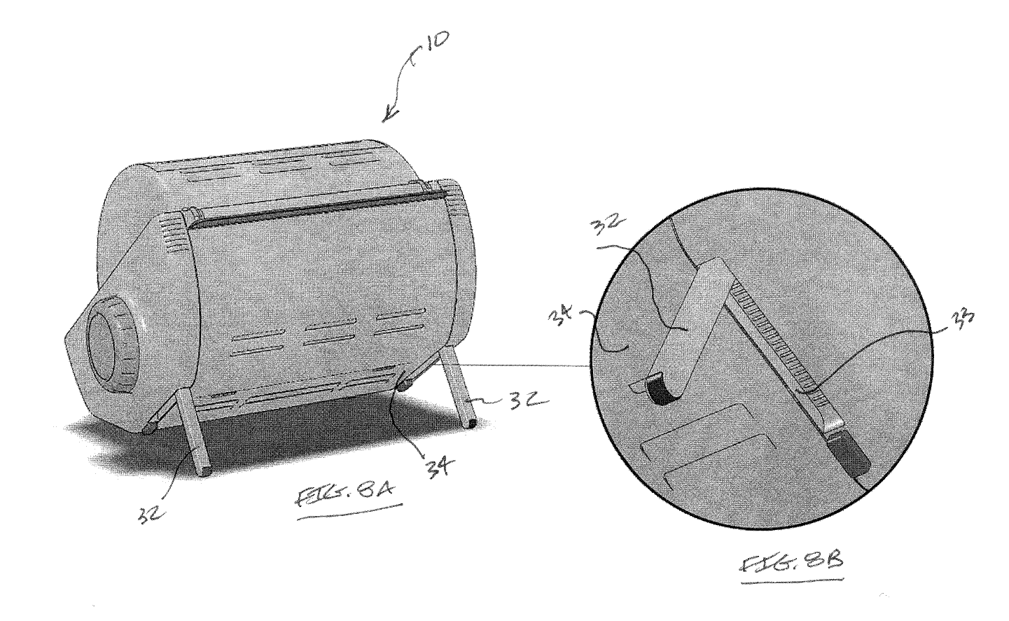

As illustrated in FIGS. 8A and 8B, in an example embodiment, the rear support elements 32 can be provided in the form of a pair of legs, wherein each leg is positioned at opposite ends of the bottom rearward surface 34. The legs can be configured to retract into slots or channels 33 disposed in the bottom rearward surface for storage. This is but one example embodiment of how the rear support elements 32 can be configured for purposes of reference, and it is to be understood that many other mechanical configurations are possible and intended to be within the scope of this disclosure.

FIG. 2 illustrates an example embodiment rotisserie oven 10 with the upper member 14 in a retracted or tilted upward position, thereby exposing the cooking chamber 30 within the lower member. A spit assembly 35 is disposed within the cooking chamber and is configured to accommodate attachment of a food article for cooking within the chamber. The spit assembly 35 comprises a pair of spit plates 36 having one or more spit rods 37 extending in parallel fashion therebetween. In an example embodiment, the spit plates 36 are configured having closed enclosures sized to accommodate respective spit rod ends therein to facilitate attachment of the spit rods between the plates.

One or more of the spit rod plates 36 include means for engaging the motorized mechanism in the lower housing to facilitate rotation of the spit assembly 35 in the cooking chamber. In an example embodiment, one or both of the plates include gear teeth positioned along an outer edge that are sized and positioned to engage a driving gear (not shown) extending from a wall surface of the cooking chamber and that is attached to the electric motor. The cooking chamber and spit assembly are configured to accommodate rotational movement of the spit assembly thereby when the electric motor is activated, and are configured to permit the spit assembly to be easily inserted into and removed from the cooking chamber.

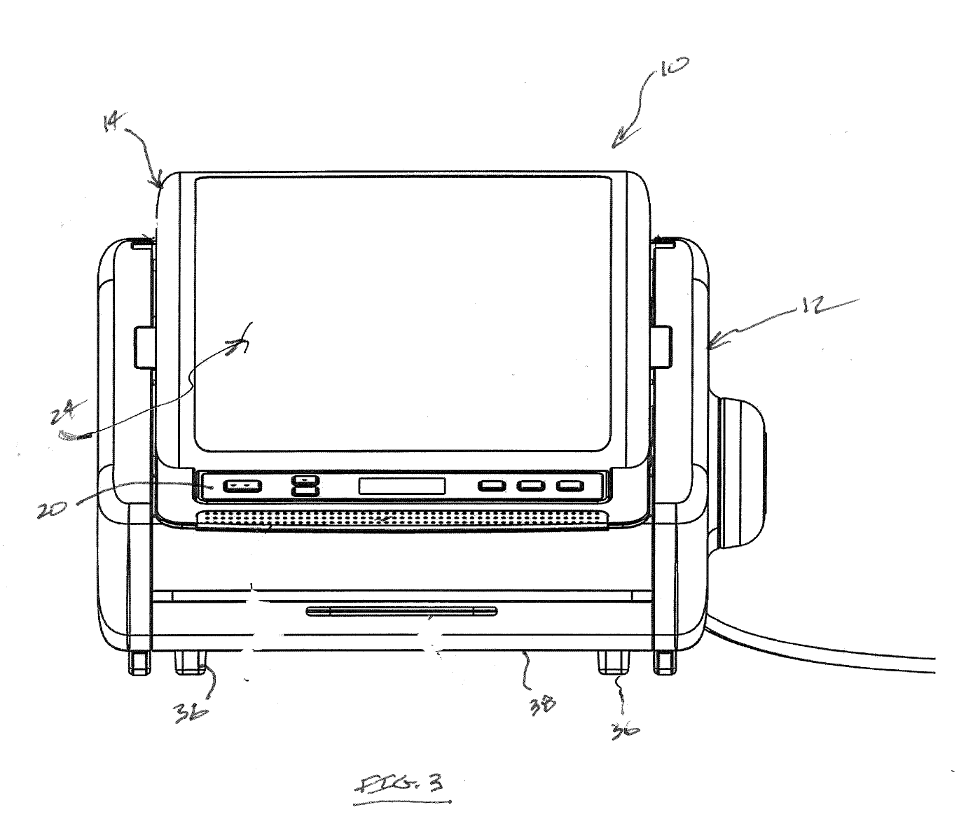

FIG. 3 is a front view of an example embodiment rotisserie oven 10 with the upper member 14 in a closed position relative to the lower member 12, and showing the position of the upper member window 24, the upper member handle 26, and the lower member control panel 20. The lower member additionally includes one or more front support elements or feet 39 that are positioned along a lower member bottom frontward surface 38. The front support elements 39 are configured to support the lower member on a horizontal supporting surface when the rotisserie oven is oriented in a cooking position, e.g., when the rear support members 32 are extended outwardly from the lower member bottom rearward surface 38 to place the oven into a forward-oriented position.

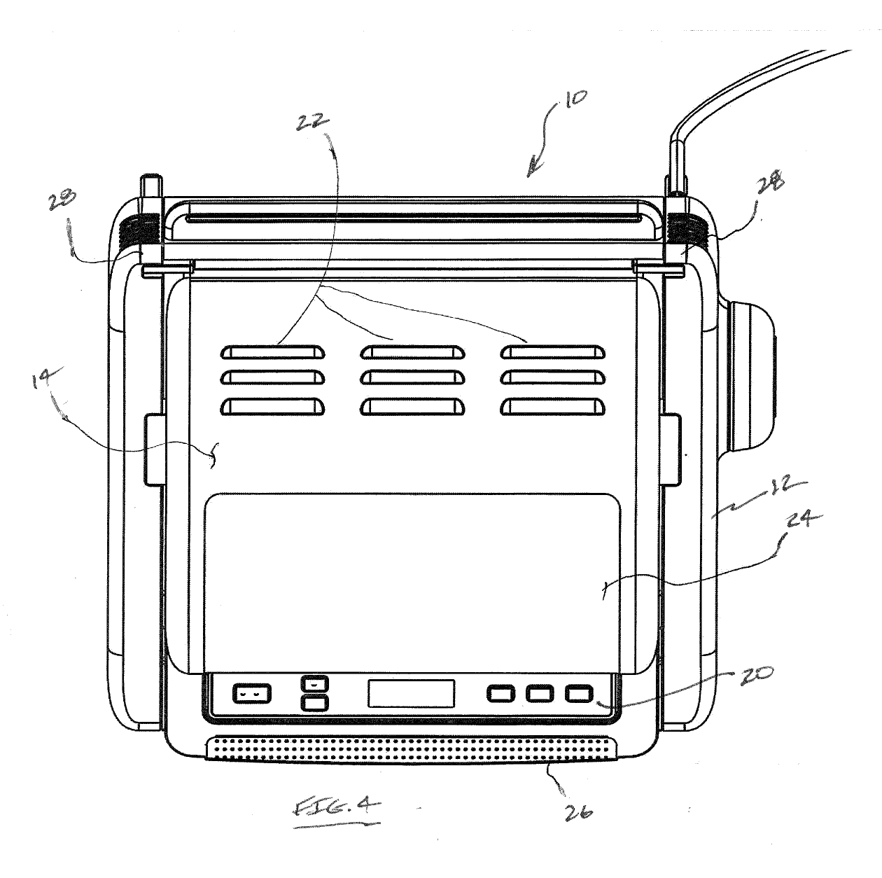

FIG. 4 is a top view of an example embodiment rotisserie oven 10 with the upper member 14 in a closed position relative to the lower member 12, and showing the position and number of the vents 22 in the upper member along with the window 24, the handle 26, and the lower member control panel 20. Further illustrated is the location of the engagement members or features 28 of the upper and lower members.

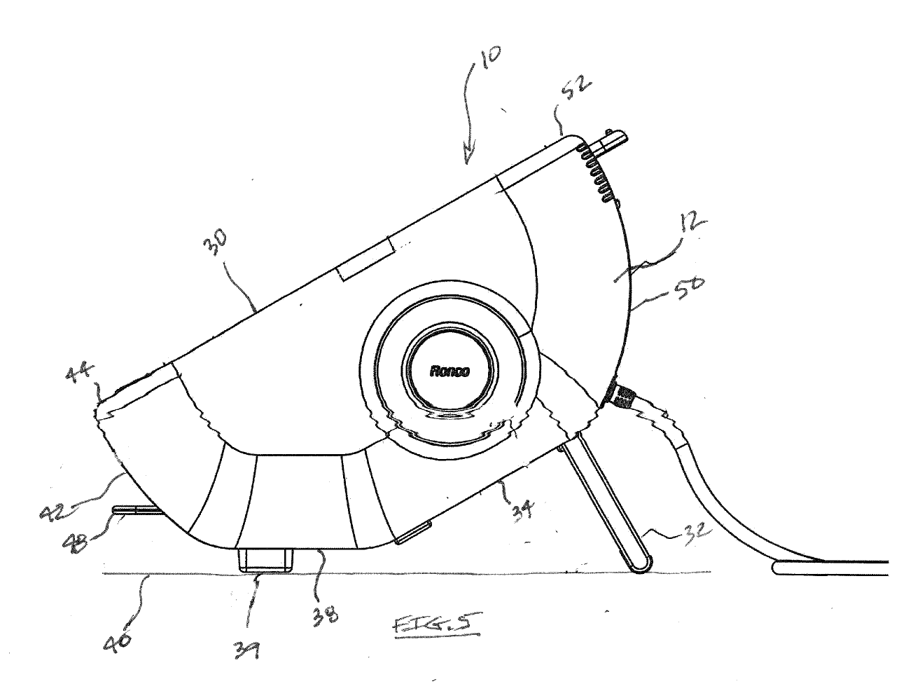

FIG. 5 is a side view of an example embodiment rotisserie oven 10 with the upper member removed, showing the lower member 12 oriented in a cooking position with the cooking chamber 30 exposed and opened. This view best illustrates the relationship between the differently-oriented lower member bottom surfaces relative to a horizontal support surface 40. Moving from left to right along the lower member 12, it has a front surface 42 that extends downwardly a distance from a forward edge 44 to the bottom frontward surface 38 having the front support elements 39 attached thereto. In an example embodiment, the bottom frontward surface 38 is substantially parallel with the horizontal support surface when the rotisserie oven is oriented in its cooking position, thereby representing the bottom-most portion of the cooking chamber.

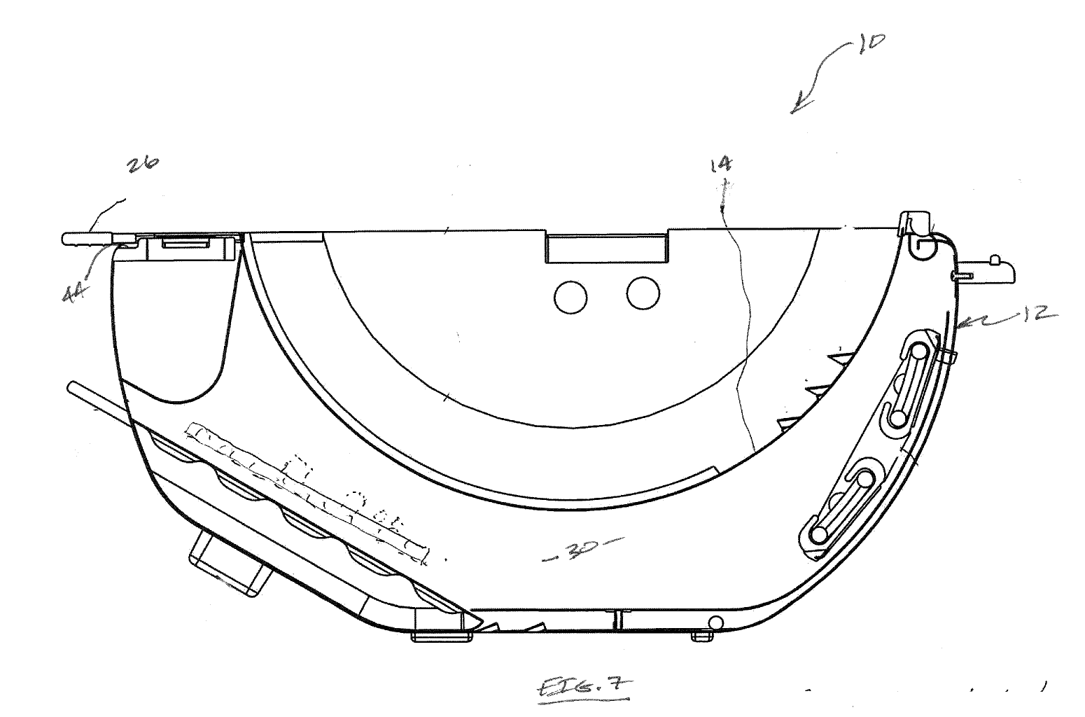

As shown in FIGS. 6 and 7, the rotisserie oven includes a removable grease pan 46 that is disposed within the lower member 12 and that is positioned long an inside wall of the bottom frontward surface 38, e.g., in parallel with the bottom frontward surface 38, to collect cooking fluids by gravity flow to the bottom of the cooking chamber. A handle 48 is attached to the grease pan to facilitate removing the pan, and the collected fluids captured therein, from the front of the lower member 12. In practice, it is desired that the grease pan 46 be removed from the oven and emptied while the oven is in the cooking position, e.g., as illustrated in FIG. 5.

Moving away from the bottom frontward surface 38, the lower member bottom surface transitions upwardly to the bottom rearward surface 34 to which the rear support members 32 are connected. As illustrated, when the rotisserie oven is oriented in a cooking position, the rear support members 32 operate to move and maintain the bottom rearward surface 34 in a position that is at a forward angle relative to the horizontal support surface, e.g., at an angle that is sufficient to place the bottom frontward surface 38 parallel with the horizontal support surface. In an example embodiment the forward angle is greater than about 10 degrees, in the range of from about 15 to 60 degrees, and in an example embodiment between about 20 to 45 degrees. Moving away from the bottom frontward surface 38, the lower member has a back surface 50 that curves upwardly from the bottom frontward surface 38 to a rearward edge 52.

Thus, as described herein, when the rotisserie oven 10 is oriented in its cooking position, the lower member 12 is oriented such that its back surface 50 and its rearward edge 52 is positioned significantly higher than its front surface 42 and its forward edge 44. Positioning the lower member 12 in this manner enables easy frontal access to the cooking chamber 30 for the purpose of introducing and removing a food article to be cooked, and when the cooking article is being cooked it enables easy viewing through the upper member window.

FIG. 6 illustrates a side cross-sectional view of the rotisserie oven 10 with the upper member removed, and the lower member 12 oriented in a storage position. In this position, the rear support members have been removed or retracted so that the lower member 12 is removed from its forward-oriented position, causing the lower member to shift rearward such that the front support elements 39 extending from the bottom frontward surface 38 no longer engage the horizontal supporting surface, and the bottom rearward surface 34 is now parallel with the horizontal supporting surface 40. As illustrated, the lower member may include one or more feet or pads 51 disposed along the bottom rearward surface 34 for purposes of resting the lower member in the storage position. In the storage position, the opening to the cooking chamber is substantially parallel with the horizontal supporting surface.

The lower member 12 includes a heating element assembly 53 positioned within the cooking chamber along an inside portion of the back surface 50, which assembly may comprise one or more heating elements 54. As illustrated, in an example embodiment, the heating element assembly 53 extends longitudionally along a length of the cooking chamber back wall. The heating elements may be openly exposed within the cooking chamber or may be covered, e.g., behind a wall or screen adjacent the cooking chamber. As noted earlier, the lower member includes a grease pan 46 positioned within the cooking chamber along the bottom frontward surface 38 and connected to a handle 48 for easy removal and replacement. In an example embodiment, the grease pan can include a broiler cover or the like 56 disposed thereover comprising an arrangement of slots or other configured openings.

A feature of rotisserie ovens as disclosed herein is that they are specially configured to provide an improved degree of space-saving storage, thereby making such ovens more practical to buy and keep available for repeated use. The ovens as disclosed herein achieve this through the use of an enclosure engineered to provide a cooking orientation having one height profile, and a storage orientation having another reduced height profile, and further through the use of oven members that are designed to be stored within the oven without contributing to the reduced storage height profile.

In an example embodiment, ovens as disclosed herein achieve this through the use of retracting and/or removable rear support members that permit the oven to be shifted from a forward-oriented cooking position (where the rear edge is significantly higher than the front edge), to the storage position (where the height of the rear and front edges are substantially the same). The storage position provides a reduced overall height profile of the oven as measured from a horizontal supporting surface. Additionally, the cooking chamber is sized to accommodate placement of the spit assembly therein when the spit assembly is in a disassembled form.

In an example embodiment, the height of the rotisserie oven in the stored position is less than about 75 percent of the height of the rotisserie oven in the cooking position, is less than about 65 percent of the height, and in a preferred embodiment is about 50 percent or less of the height of the rotisserie oven in the cooking position.

As noted above, the spit assembly comprises a pair of spit plates having one or more spit rods interposed therebetween. The spit assembly can be disassembled by simply removing the spit rods from the spit plates. In this form, as illustrated in FIG. 6, the spit plates 36 can be positioned within the cooking chamber, e.g., side-by-side of one another, adjacent an inside wall of the bottom frontward surface 38, and the spit rods 37 can be positioned running longitudionally along the same wall. The ability to store the spit assembly within the rotisserie oven when in a storage position further operates to ease storage as all oven elements are self-contained within the oven.

FIG. 7 is similar to FIG. 6 in that it illustrates the rotisserie oven lower member 12 in a storage position. However, FIG. 7 illustrates the complete rotisserie oven as now combined/stored within the upper member 12. Specifically, the upper member 14 is configured such that it can be removed from its position on top of the lower member in a cooking position, inverted, and then inserted into the cooking chamber.

In an example embodiment, at least 75 percent of the inverted upper member can be disposed within the cooking chamber, and preferably at least 85 percent. In a most preferred embodiment, the inverted upper member is completely disposed within the cooking chamber of the lower member such that the overall height profile of the combined upper and lower oven members in such storage position is substantially the same as the lower member when it is in a storage position alone. In an example embodiment, the upper member 14 is inverted so that its lid 26 rests adjacent lower member front edge 44.

Further, the configuration of the upper member and the cooking chamber permits the upper member when inverted to fit completely within the cooking chamber while the disassembled spit assembly is also stored therein, thereby providing a rotisserie oven that is capable of consuming less storage space (thus being able to be more easily stored in conventional areas such as kitchen drawers and the like) than conventional rotisserie ovens. The ability to provide a rotisserie oven having such a space-saving storage ability is significant as it permits such an appliance to be easily stored within a kitchen drawer or the like, thereby avoiding having to consume valuable counter space.

Other modifications and variations of rotisserie ovens as disclosed herein configured in the manner described above with reference to the figures will be apparent to those skilled in the art. It is, therefore, to be understood that within the scope of the appended claims, this invention may be practiced otherwise than as specifically described.

What is claimed is:

1. A rotisserie cooking device comprising:
an enclosure comprising a lower member and an upper member removably connected to the lower member to form a cooking chamber therebetween;
one or more heating elements disposed within the enclosure;
a spit assembly rotatably disposed within the cooking chamber; and
support means connected to the enclosure for moving the enclosure between a first storage position to a second operating position, wherein when in the first position the height of the device from a support surface is less than that when in the second position.

2. The device as recited in claim 1 wherein the upper member, when removed from the lower member, is configured to fit within the cooking chamber.

3. The device as recited in claim 2 wherein at least 75 percent of the upper member fits within the lower member.

4. The device as recited in claim 1 wherein the lower member has a semi cylindrical configuration, and wherein the upper member has a semi cylindrical configuration to fit concentrically within the lower member when detached from the lower member.

5. The device as recited in claim 1 wherein the spit assembly comprises a pair of opposed plates with two or more spit rods extending therebetween, and where the rods are removable from the plates to permit storage within the cooking chamber.

6. The device as recited in claim 5 wherein the spit assembly disassembled rods and plates are interposed between the upper and lower members when the lower member is detached from the upper member and disposed therein.

7. The device as recited in claim 1 further comprising a motor for rotating the spit assembly within the cooking chamber, the motor being attached to the lower member and including a gear element that engages the spit assembly.

8. The device as recited in claim 1 wherein the support means comprise one or more elements that extend from an outside surface of the lower member.

9. The device as recited in claim 8 wherein the one or more elements are connected to a base of the lower member and are located adjacent a backside portion of the lower member.

10. The device as recited in claim 9 wherein movement of the one or more elements from a first position to a second position causes the backside portion of the lower member to be moved upwardly and a frontside portion of the lower member to be tilted forward into a cooking position.

11. The device as recited in claim 1 wherein the upper member is connected with the lower member so that the upper member can be pivoted upwardly to provide access to the cooking chamber.

12. A rotisserie cooking device comprising:
an enclosure comprising a lower member and an upper member removably connected with the lower member to form a cooking chamber therebetween, wherein the upper member is configured when removed from the upper member to fit substantially within the lower member;
a heating element disposed within the enclosure;
a spit assembly rotatably disposed within the cooking chamber; and
support means connected to the enclosure for placing the enclosure in a first storage position and in a second operating position, wherein when in the first position the height of the device from a support surface is less than that when in the second position.

13. The device as recited in claim 12 wherein the support means is connected to the lower member, and when in the second operating position raises a base of the lower member upwards and tilts the lower member forward.

14. The device as recited in claim 13, wherein when in the second operating position, a back wall of the lower member is higher than a front wall of the lower member.

15. The device as recited in claim 12 wherein the upper member is formed from a transparent material.

16. The device as recited in claim 12 wherein the heating element is attached to the lower member, wherein the device comprises a motor attached to the lower member, and wherein a gear is attached to the motor and is in contact with the spit assembly.

17. The device as recited in claim 12 comprising a tray disposed along a wall surface of the lower member for collecting fluids from within the cooking chamber, the tray being removable from the enclosure.

18. The device as recited in claim 17, wherein when the enclosure is in the second operating position, the tray is oriented at a bottom position of the cooking chamber.

19. The device as recited in claim 12 wherein the support means is in the form of one or more elements that are movably attached to the lower member, and wherein the one or more elements are recessed into the lower member when in the first position.

20. The device as recited in claim 12 wherein the upper member is configured so that, when detached from the lower member, at least 75 percent of the upper member is disposed within the lower member.

21. The device as recited in claim 20 wherein the upper member and the lower members are each configured having a semi cylindrical shape, and wherein the upper member when removed from the lower member fits concentrically within the lower member.

22. The device as recited in claim 12 wherein the upper member is connected with the lower member to pivot upwards to provide access to the cooking chamber.

23. A method for providing a collapsible rotisserie cooking device comprising the steps of:
moving a support means that is attached to an enclosure comprising an upper and a lower member from a cooking position to a storage position, wherein when in the storage position the height of the enclosure from a device support surface is reduced as compared to the cooking position;
detaching the enclosure upper member from the lower member;
removing a spit assembly from a cooking chamber disposed within the enclosure; and
placing the upper member within the lower member such that at least 75 percent of the upper member is disposed within the lower member.

24. The method as recited in claim 23 wherein when in the cooking position, a base portion of the lower member is raised upwardly from the support surface, and the enclosure is tilted forward.

25. The method as recited in claim 23 wherein when in the cooking position, a tray that is disposed within the enclosure is oriented at a bottom of the cooking chamber.

26. The method as recited in claim 23 wherein the support means comprises one or more elements connected with the lower member adjacent a back wall, and wherein when in the storage position the one or more elements are recessed within the lower member.

27. The method as recited in claim 23 comprising disassembling the spit assembly by removing one or more spit rods from a pair of opposed plates, and placing the disassembled spit assembly into the cooking chamber.

28. The method as recited in claim 27 wherein the disassembled spit assembly is placed within the cooking chamber before the upper member is disposed in the lower member.

29. The method as recited in claim 23 wherein the step of placing comprises inverting the upper member after being removed from the lower member and before disposing within the lower member.

30. The method as recited in claim 29 wherein the upper member has a semi cylindrical configuration and the lower member has a semi cylindrical configuration, and wherein the upper member is disposed concentrically within the lower member.
